(19) United States
(12) Patent Application Publication
(10) Pub. No.: US 2015/0110927 A1
(43) Pub. Date: Apr. 23, 2015

(54) EDIBLE COATING AND COATED FOOD PRODUCT

(71) Applicant: Conopco, Inc., d/b/a UNILEVER, Englewood Cliffs, NJ (US)

(72) Inventors: Beata Bartkowska, Bedford (GB); Hangsheng Li, Shanghai (CN); Chunbo Ran, Shanghai (CN); Desheng Xu, Bromsgrove (GB)

(73) Assignee: Conopco, Inc., d/b/a UNILEVER, Englewood Cliffs, NJ (US)

(21) Appl. No.: 14/363,062

(22) PCT Filed: Dec. 13, 2012
(86) PCT No.: PCT/EP2012/075357

§ 371 Date: Jun. 5, 2014

(30) Foreign Application Priority Data
Dec. 14, 2011 (CN) PCT/CN2011/002098
Feb. 8, 2012 (EP) 12154383

(51) Int. Cl. A21D 15/08; A23L 1/00

(52) U.S. Cl. CPC A21D 15/08; A23L 1/0032; A23V 2002/00
USPC 426/97; 426/99; 426/98; 426/310

(57) ABSTRACT

Disclosed is an edible coating, a food product coated with the coating and the method for manufacturing the food product. The coating comprises a first layer comprising first edible oil and a second layer comprising a hydrophobic edible particle wherein the hydrophobic edible particle has a diameter from 20 nm to 500 microns. The food product having the coating is resistant to becoming soggy.

### TECHNICAL FIELD

The present invention relates to an edible coating, a food product coated with the edible coating and a method for manufacturing the food product. More particularly, the invention is directed to coating comprising a first layer comprising first edible oil, and a second layer comprising a hydrophobic edible particle. When a food product has such coating, the food product unexpectedly remains crunchy.

### BACKGROUND OF THE INVENTION

Frozen confection cones, pretzels, cookies, crackers and other products of this character are well known. Such products have characteristics that are similar in that they are enjoyed most by consumers when dry and crunchy. These products, however, can often become soggy or undesirably soft when subjected to, for example, moisture and/or temperature changes. Products of this nature may be stored for long periods of time in places where the climate is not consistent or they can be frozen, thawed, re-frozen or simply subjected to moisture as a result of being placed in conventional freezer or refrigeration cabinets. Such products may also be subjected to moisture as a result of being in contact with high moisture components in complex food products, such as the ice cream component in an assembled ice cream cone.

When products, typically enjoyed dry and crunchy, become soggy, they are not enjoyed by the consumer, often discarded and can result in brands getting a negative reputation for quality.

Efforts have been disclosed for making coated food products. In U.S. Patent Application with publication No. 2004/0253346 A1, liquid filled, wafer covered, edible communion cups that may be coated with an edible wax are described.

Other efforts for edible moisture bather are disclosed. In U.S. Patent Application with publication No. US 2004/0101601 A1, An edible moisture bather for food products is said to be provided comprising an edible microparticulated high melting lipid and an edible low melting triglyceride blend.

Still other efforts have been disclosed for coating materials for food. In U.S. Pat. No. 6,902,752, a coating material for confectionery/bakery use comprising as main components an oil and fat and a sugar is described.

None of the publications above describes a coating and food product having the coating wherein the coating comprises a first layer comprising first edible oil, and a second layer comprising a hydrophobic edible particle wherein the hydrophobic edible particle has a diameter from 20 nm to 500 microns.

There is an increasing interest to develop food products that do not become undesirably soggy or soft while being stored and prior to consumption, especially cones which are subjected to frozen confection. Moreover, there is an increasing interest to develop such a stable product without adding fat and calories to the same and without compromising taste. The present invention, therefore, is directed to an edible coating, a food product coated with the edible coating and a method for manufacturing the food product. More particularly, the invention involves a coating comprising a first layer comprising first edible oil, and a second layer comprising a hydrophobic edible particle. Such a coating surprisingly keeps the food product crunchy.

### Definitions

### Edible Oil

“Edible oil” as used herein means any oil that is suitable for human consumption. Usually the edible oil is purified fat of plant origin, which is liquid at 25° C. under atmospheric pressure.

### Hydrophobic

“Hydrophobic” is used herein to describe a molecule or a portion of molecule that is repelled from a mass of water, or a surface that has a Contact Angle (CA) of water greater than 90° at 25° C. Illustrative examples of hydrophobic molecules include the alkanes, oils, fats, and greasy substances in general. Contact angle (CA), as used herein, means the angle at which a water/vapor interface meets a solid surface at a temperature of 25° C. Such an angle may be measured with a goniometer or other water droplet shape analysis systems with water droplet of 5 μl and at 25° C. “Ultrahydrophobic” as used herein means having a contact angle of at least 140° against water.

### Diameter

“Diameter” as used herein means the largest measureable distance on a particle in the event that a well-defined sphere is not generated. The diameter of particles in this invention means the diameter of particles in the coating after the coating is formed. It may be measured for example by scanning electron microscopy (SEM). The value of diameter is obtained as number average value of at least ten particles.

### Thickness of Layer

“Thickness of layer” as used herein means the dimension perpendicular to the largest surface of the layer. The thickness of the first layer in present invention means the thickness of layer comprising the edible oil. The thickness of the second layer in the present invention means the thickness of layer comprising a hydrophobic edible particle. The thickness of layer may be measured by optical microscopy and/or electron microscopy.

### Miscellaneous

Except in the examples, or where otherwise explicitly indicated, all numbers in this description indicating amounts of material or conditions of reaction, physical properties of materials and/or use may optionally be understood as modified by the word “about”.

It should be noted that in specifying any range of values, any particular upper value can be associated with any particular lower value.

For the avoidance of doubt, the word “comprising” is intended to mean “including” but not necessarily “consisting of” or “composed of”. In other words, the listed steps or options need not be exhaustive.

The disclosure of the invention as found herein is to be considered to cover all embodiments as found in the claims as being multiply dependent upon each other irrespective of the fact that claims may be found without multiple dependency or redundancy.

Where a feature is disclosed with respect to a particular aspect of the invention (for example a composition of the invention), such disclosure is also to be considered to apply to any other aspect of the invention (for example a method of the invention) mutatis mutandis.

### SUMMARY OF THE INVENTION

In a first aspect, the present invention is directed to a coating, the coating comprising:
(a) a first layer comprising first edible oil;
(b) a second layer comprising a hydrophobic edible particle;
   wherein the hydrophobic edible particle has a diameter from 20 nm to 500 micron.

In a second aspect, the present invention is directed to a food product having the coating of the present invention.

In a third aspect, the present invention is directed to a method for manufacturing a food product, the method comprising the steps of:
(a) forming a first layer comprising first edible oil;
(b) forming a second layer comprising a hydrophobic edible particle;
   wherein the hydrophobic edible particle has a diameter from 20 nm to 500 micron.

All other aspects of the present invention will more readily become apparent upon considering the detailed description and examples which follow.

### DETAILED DESCRIPTION

The first layer comprises first edible oil. There is no limitation with regards to the first edible oil. The preferred first edible oil of this invention comprises coconut oil, corn oil, cottonseed oil, olive oil, palm oil, soybean oil, peanut oil, pumpkin seed oil, corn oil, sunflower oil, peanut oil, safflower oil, sesame oil, or a mixture thereof More preferably, the first edible oil comprises palm oil, coconut oil, sunflower oil, olive oil, palm oil, peanut oil, soybean oil, or a mixture thereof. Even more preferably, the first edible oil comprises coconut oil, palm oil or a mixture thereof.

For example, without limitation, the first edible oil suitable for use in this invention includes palm oil from Mauser UK Ltd. (UK), and/or coconut oil from Sime Darby Unimills (The Netherlands).

In a preferred embodiment, the first layer comprises the first edible oil in amount from 1 to 90% by weight of the first layer, more preferably from 5 to 80%, even more preferably from 10 to 70%, most preferably from 30 to 60%.

In the present invention, the thickness of the first layer is preferably in the range from 10 micron to 2 cm, more preferably from 20 microns to 1 cm, even more preferably from 50 microns to 5 mm, most preferably from 100 microns to 1 mm.

Apart from the first edible oil, the first layer additionally comprises sugar to alter the taste. The preferred amount of sugar is from 5 to 90% by weight of the first layer, more preferably from 10 to 80%, even more preferably from 20 to 70%. Optionally, the first layer may comprise cocoa powder. Preferably, the first layer comprise cocoa powder from 1 to 50% by weight of the first layer, more preferably from 3 to 30%, even more preferable from 5 to 20%. Other optional ingredients such as flavor, coloring and/or the like may also be present in the first layer.

The second layer comprises a hydrophobic edible particle wherein the hydrophobic edible particle has a diameter from 20 nm to 500 microns. Preferably, the hydrophobic edible particle has a diameter from 50 nm to 200 microns, more preferably from 200 nm to 100 microns, even more preferably from 500 nm to 20 microns.

In a preferred embodiment, the second layer comprises the hydrophobic edible particle in amount from 10 to 100% by weight of the second layer. More preferably, the amount of the hydrophobic edible particle is from 20 to 90% by weigh of the second layer, even more preferably from 30 to 80%.

The thickness of the second layer is preferably in the range from 1 micron to 2 cm, more preferably from 5 microns to 5 mm, even more preferably from 20 microns to 2 mm, most preferably from 50 microns to 500 microns.

Without being bound to any explanation or theory, the present inventors believe that the hydrophobicity of the particle is necessary to repel water and/or moisture. The hydrophobic edible particle is obtainable either from a core-shell particle by coating an edible particle with an edible hydrophobic material, or from an edible particle wherein the material of edible particle itself is hydrophobic.

When the hydrophobic edible particle is the core-shell particle, the edible core particle may be hydrophobic or hydrophilic. The suitable edible core particle comprises inorganic particle, starch, wax or a mixture thereof Preferably, the edible core particle is inorganic particle. More preferably, the core edible particle comprises calcium carbonate, calcium chloride, barium sulphate, silica, titanium dioxide, zinc oxide, mica, or a mixture thereof, even more preferably the core edible particle comprises calcium carbonate.

Exemplary edible core particle suitable for use in this invention includes calcium carbonate (for example Socal R1E from Solvay Belgium).

There is no limitation with regards to the hydrophobic shell material for coating the edible core particle except that the hydrophobic material is edible. Such hydrophobic edible material preferably comprises fatty acid, fatty ester, second edible oil or a mixture thereof. The preferred hydrophobic edible material comprises stearic acid, oleic acid, palm oil, coconut oil, sunflower oil, olive oil, peanut oil, soybean oil, or a mixture thereof. More preferred hydrophobic edible material comprises oleic acid, palm oil, coconut oil, or mixture thereof. It is to be noted that the modification of particle to be hydrophobic is necessary before the preparation of the second layer if the core edible particle is hydrophilic.

The preferred amount of the hydrophobic edible shell material to coat the edible core particle is from 0.001 to 30% by weight of the entire edible particle. More preferred amount is from 0.01 to 10% by weight of the entire edible particle. Even more preferred amount is from 0.1 to 5% by weight of the entire edible particle.

When preparing the core-shell particle, the weight ratio of edible shell material to edible core particle is preferably in the range from 1:10000 to 5:1, more preferably from 1:1000 to 1:1, even more preferably from 1:200 to 1:5, most preferably from 1:50 to 1:10.

It is also within the scope of the present invention the hydrophobic edible particle is obtainable from an edible particle wherein the material of this edible particle itself is hydrophobic. Preferably, such hydrophobic edible particle comprises wax. More preferably, the hydrophobic edible particle is selected from montan wax, carnauba wax or a mixture thereof. To produce hydrophobic edible wax particle, any physical dispersion or comminution method is acceptable. Preferably, the method to generate wax particle comprises jet mill method, supercritical method, or combination thereof.

According to the present invention, the first layer is different from the second layer. The first layer of the coating may or may not contact the second layer of the coating. However, it is preferred that the first layer contacts the second layer, more preferably along the largest surface of the first layer.

When the two layers contact along the largest surface of the first layer, it is preferable that the part of second layer embeds into the first layer to form an overlapped layer to improve the durability of the coating. The only requirement of overlapping is to make sure at least part of the second layer does not overlap, and therefore is distinct from the first layer. Thus, the first layer can fully embed into the second layer. But the second layer can not fully penetrate into the first layer.

The food product having the coating of the present invention is also within this invention. The food product of the present invention may be any food product. Preferably, the food product of this invention is susceptible to moisture or water damage as a result of being in contact with high moisture or water, or is easily impaired in quality by losing moisture to an environment of low moisture. More preferably, the food product may comprise wafer, cookie, potato chip, cereal, fruit, or the like.

The coating is capable of rendering at least part of the food product to be hydrophobic, preferably ultrahydrophobic. The ultrahydrophobic surface of the food product of this invention has a contact angle against water from 140° to 180°, preferably from 140° to 170°, and even more preferably, from 150° to 160°.

The food product having the coating is preferably in contact with a high moisture component. More preferably, the coating of the food product is in contact with the high moisture component. Even more preferably, the second layer of the coating is in contact with the high moisture component. Most preferably, the second layer of the coating is in contact with the high moisture component and the coating is sandwiched between the food product and the high moisture component.

In a preferred embodiment the food product is in contact with a component comprising from 30% to 100% of water by weight of the component. In a more preferred embodiment, the treated food product is in contact with a component comprising from 50% to 80% of water by weight of the component. In a particularly preferred embodiment the food product is a wafer (for example a wafer cone) and the component is a frozen confection product such as an ice cream, water ice, sherbet, or the like.

The method for manufacturing such a food product is also within the scope of the present invention. The method comprises the steps:
(a) forming a first layer comprising first edible oil;
(b) forming a second layer comprising a hydrophobic edible particle;
   wherein the hydrophobic edible particle has a diameter from 20 nm to 500 micron.

To form the first layer comprising the first edible oil, any method is allowed so long as the first layer comprises the first edible oil is formed. The preferred method comprises spraying method, the pour-and-suck-out method, brushing method, or a combination thereof, or the like. More preferably, the method for forming the first layer is the spraying method. Such spraying may be achieved for example with a fluid atomizing spray gun. The amount of the first oil is not limited but preferably the entire surface targeted is coated.

Any method is acceptable to form a second layer comprising a hydrophobic edible particle. The method preferably comprises spraying, sprinkling, the pour-and-spread method, or a combination thereof. More preferably, the method for forming the second layer is the spraying method. Such spraying may be achieved for example with a fluid atomizing spray gun. The amount of hydrophobic edible particle is not limited but preferably the entire surface targeted is coated.

There is not limitation with regards to the sequence of step (a) and step (b) provided that the coating of the present invention is formed onto the food product. It is preferred that step (a) is carried out followed by step (b). In a more preferred embodiment, step (a) is carried out closely followed by step (b). In an even more preferred embodiment, step (b) is carried out just after the first edible oil of the first layer become semi-solidified. The preferred way to treat the first layer to be semi-solidified is cooling. Without being bound to any theory or explanation, the hydrophobic edible particles are believed to be partially embedded into the first layer in such case to form a robust bonding between the first layer and the second layer while remaining the food product crunchy.

### EXAMPLES

### Materials

The materials involved in the examples include:
Precipitated calcium carbonate (PCC) (Type: Socal R1E) from Solvay (Belgium);
Oleic acid from Sinopharm Group Co. Ltd. (China);
Palm oil from Mauser UK Ltd. (UK);
Coconut oil from Sime Darby Unimills (The Netherlands);
Montan wax and carnauba wax from Beijing Likang Weiye Technology Co., Ltd (China);
Commercially available ice cream couverture comprising palm oil and coconut oil; and commercially available ice cream cone.

### Example 1

This example demonstrates the manufacture of ice cream cone having the coating comprising an edible oil and a second layer comprising a PCC modified by oleic acid. The ice cream cone having such a coating can resist becoming soggy by ice cream melting.

### Experimental Section

(a) Preparation of OLEIC ACID MODIFIED PCC

20 g PCC was dispersed in 45 ml deionised water at temperature of 75° C. followed by adding 0.511 g oleic acid. Then, the mixture was stirred at temperature of 40° C. for 1 hour, forming oleic acid-coated PCC. Subsequently, the mixture was washed by ethanol, filtrated, and dried naturally.
(b) Preparation of Coating and Manufacturing the Ice Cream Cone having the Coating

Commercially available ice cream couverture was placed at drying oven (DHG-9053A, Shanghai Jing Hong Laboratory Instrument Co., Ltd., China) at the temperature of 40° C. for 2 hours to obtain the melt couverture. Then, the melt couverture was coated onto a commercially available ice cream cone manually. The coated ice cream cone is placed into a freezer at the temperature of −18° C. for 30 seconds to form a semi-solidified couverture. Oleic acid coated PCC was manually sprinkled onto the couverture. The cone was then manually rotated to obtain a uniform and totally covered layer of particle. The corresponding amount of each material followed Table 1.
(c) Characterization

Scanning electron microscopy (S-4800, Hitachi, Japan) was used to measure the diameter of particles and the thickness of layers. The surface of the second layer of the coating was observed to measure the diameter of particle. The cross section of the coating was observed to measure the thickness of each layer.

Drop shape analysis system 100 (DSA 100, Kniss, Germany) was used to measure the contact angle by applying Laplace fitting. The test was conducted on the second layer of the coating using deionised water drops of around 5 μL on five different points of each surface. The value of contact angle was obtained as average value of the five points.
(d) Test of Water Damage Resistance

Two commercially available ice cream cones were treated to have coating A and C respectively. 20 g commercially available ice cream was placed into each coated cone. Then, these two coated ice cream cones were stored in a fridge at 4° C. for 20 hours.

TABLE 1

| | | Second layer | | |
|---|---|---|---|---|
| | First layer | oleic acid coated PCC | | |
| | Couverture | Diameter | Weight | Contact angle |
| Coating | (g) | (micron) | (g) | (Degrees) |
| A | 5 | — | — | 90 |
| B | 4 | 2.2 | 0.5 | 144 |
| C | 4 | 2.2 | 1 | 148 |
| D | 4 | 2.3 | 1.5 | 154 |

### Results

The ice cream cones having coating in Table 1 were prepared. By SEM imaging, the oleic acid coated CaCO₃ was found to have a diameter around 2.2 microns. The cross section of coating C was also observed by SEM. It was found that the thickness of oleic acid coating PCC layer is from 150 to 200 microns and the thickness of the couverture is from 200 to 300 microns.

By replacing part of couverture by oleic acid coated PCC, the surface contact angle was found to be increased to over 140°, manifesting the coating is ultrahydrophobic and has a good water repellence properties.

After the coated cones filled with ice cream were stored for 20 hours, it was found that the color of the bottom part of the ice cream cone coated only by couverture (sample A) was darker and partly concaved. By touching by finger, the cone was found to have become soggy by the melting of ice cream. In contrast, the ice cream cone having a coating comprising a layer of couverture and a layer of oleic acid modified PCC particles remained the same color. When touching the cone, it was still hard, indicating that it remained crunchy.

### Example 2

This example demonstrates manufacture of ice cream cone have the coating comprising a first layer comprising palm oil and coconut oil, and a second layer comprising a PCC modified by palm oil or coconut oil. The ice cream cone having such a coating can resist becoming soggy by water.

### Experimental Section

To prepare palm oil or coconut oil coated PCC, the amount of palm oil or coconut oil is 1 g. When testing the water damage to ice cream cone, water was used instead of ice cream melt and ice cream cones having coating A and F respectively were used to compare the water resistance performance. Other experimental conditions are similar with that of Example 1.

TABLE 2

| | First | Second layer | | | | |
|---|---|---|---|---|---|---|
| | layer | Palm oil | | Coconut oil coated | | |
| | Cou- | coated PCC | | PCC | | Contact |
| | verture | Diameter | Weight | Diameter | Weight | angle |
| Coating | (g) | (μm) | (g) | (μm) | (g) | (Degrees) |
| E | 4 | 2.3 | 1 | — | — | 154 |
| F | 4 | — | — | 2.4 | | 155 |

### Results

The ice cream cones have coating E and F were prepared according to Table 2. The diameter of oil coated PCC was found to be around 2.3 microns, similar with that of oleic acid coated PCC. The corresponding contact angles were increase to over 150°, manifesting the excellent water repellent property.

The comparison of water damage to ice cream cone having coating A and F respectively is similar with that of A and C. The ice cream cone having coating A had become soggy, while the ice cream cone having coating F remained crispy.

### Example 3

This example demonstrates manufacture of ice cream cone having the coating comprising a first layer comprising palm oil and coconut oil, and a second layer comprising a wax particle. The ice cream cone having the coating can resist becoming soggy.

### Experimental Section

The wax particle was prepared according to jet mill method by airflow pulverizer (JGM-H500, Shanghai Hualy New Superlines Co., Ltd., China). When comparing the water damage resistance, two ice cream cone having coating A and H respectively were used. The preparation of coating and manufacturing the ice cream cone having the coating, characterization and test is similar with that of Example 2.

TABLE 3

| | First | | | | | |
|---|---|---|---|---|---|---|
| | layer | Second layer | | | | |
| | Cou- | Montan wax | | Camauba wax | | Contact |
| | verture | Diameter | Weight | Diameter | Weight | angle |
| Coating | (g) | (μm) | (g) | (μm) | (g) | (Degrees) |
| H | 4 | 18 | 1 | — | — | 160 |
| I | 4 | — | — | 15 | 1 | 151 |

### Results

As shown in Table 3, the ice cream cones with coating H and I were made. The diameters of montan wax and carnauba wax are 18 and 15 microns respective by SEM observation of the first layer. The surface contact angle was also increase to over 150°. It is demonstrated that the coating has excellent water repellant property.

The comparison of water damage to ice cream cone having coating A and H respectively is similar with that of A and C. The ice cream cone having coating A had become soggy, while the ice cream cone having coating H remained crispy.

### Example 4

This example demonstrates that an ice cream cone having the coating comprising a first layer comprising an edible oil and a second layer comprising a PCC modified by oleic acid have better resistance from becoming soggy than an ice cream cone having single layer comprising edible oil and PCC modified by oleic acid.

### Experimental Section

The control coating (J) has same ingredients as sample coating C. When preparing the coating J on ice cream cone, the couverture was heated to 40° C. for 2 hours and the oleic acid coated PCC was added and mixed with the couverture to obtain the well-dispersed mixture under stirring. Then, the mixture was coated onto a commercially available ice cream cone manually. After solidified, the water contact angle of the coating was 91°.

### Result

Two ice cream cones with coating C and J are used to compare the water damage resistance with similar method described in Example 1. When testing the water damage to ice cream cone, water was used instead of ice cream melt.

The comparison of water damage to ice cream cone having coating J and C respectively is similar with that of A and C. The ice cream cone having coating J had become soggy, while the ice cream cone having coating C surprisingly remained crispy.

1. A coating comprising:
(a) a first layer comprising first edible oil;
(b) a second layer comprising a hydrophobic edible particle;
wherein the hydrophobic edible particle has a diameter from 20 nm to 500 microns, the thickness of the first layer is in the range from 10 micron to 2 cm, and the first layer is different from the second layer.

2. The coating according to claim 1 wherein the first edible oil comprises palm oil, coconut oil sunflower, oil, olive oil, peanut oil, soybean oil, or a mixture thereof.

3. The coating according to claim 1, wherein the first layer comprises the first edible oil in amount from 5 to 80% by weight of the first layer.

4. The coating according to claim 1 wherein the first layer has a thickness from 50 microns to 5 mm.

5. The coating according to claim 1 wherein the hydrophobic edible particle has a diameter from 50 nm to 200 microns.

6. The coating according to claim 1 wherein the second layer has a thickness from 20 microns to 2 mm.

7. The coating according to claim 1 wherein the hydrophobic edible particle is obtainable form coating an core edible particle with a fatty acid, a fatty ester, a second edible oil or a mixture thereof.

8. The coating according to claim 7 wherein the hydrophobic edible particle is obtainable from coating an core edible particle with oleic acid, stearic acid, palm oil, coconut oil, sunflower oil, olive oil peanut oil, soybean oil, or a mixture thereof.

9. The coating according to claim 7 wherein the edible core particle is selected from inorganic particle, starch, wax, or a mixture thereof.

10. The coating according to claim 9 wherein the edible core particle is inorganic particle.

11. The coating according to claim 10 wherein the edible core particle comprises calcium carbonate, calcium chloride, barium sulphate, silica, titanium dioxide, zinc oxide, mica, or a mixture thereof.

12. The coating according to claim 11 wherein the hydrophobic core edible particle comprises calcium carbonate.

13. The coating according to claim 1 wherein the hydrophobic edible particle comprises wax.

14. The coating according to claim 13 wherein the hydrophobic edible particle is selected from montan wax, carnauba wax, or a mixture thereof.

15. A food product having the coating of claim 1.

16. The food product according to claim 15 wherein the food product comprises ice cream wafer, cookie, potato chip, or cereal.

17. A method for manufacturing a food product of claim 15, the method comprising the steps of:
(a) forming a first layer comprising first edible oil;
(b) forming a second layer comprising a hydrophobic edible particle;
wherein the hydrophobic edible particle has a diameter from 20 nm to 500 micron.
